(19) United States
(12) Patent Application Publication
(10) Pub. No.: US 2025/0258497 A1
(43) Pub. Date: Aug. 14, 2025

(54) SYSTEMS AND METHODS FOR DATA PROCESSING OF MISSION REQUESTS TO AUTOMATICALLY NAVIGATE UNMANNED VEHICLES

(71) Applicant: DroneUp, LLC, Virginia Beach, VA (US)

(72) Inventors: Therese Rose DRUCKER, Chesapeake, VA (US); John VERNON, Virginia Beach, VA (US); Remigiusz ZAJAC, Wroclaw (PL)

(21) Appl. No.: 18/436,483

(22) Filed: Feb. 8, 2024

(51) Int. Cl. G05D 1/227; G05D 1/224; G05D 1/698; G06T 13/40

(52) U.S. Cl. CPC G05D 1/2279; G05D 1/224; G05D 1/2274; G05D 1/698; G06T 13/40

(57) ABSTRACT

A mission management compute device is configured to assign each mission from a plurality of missions to an operator from a plurality of operators. Each operator from the plurality of operators is uniquely associated with at least two unmanned vehicles from a plurality of unmanned vehicles. A plurality of ground control compute devices is operatively coupled to the mission management compute device. Each ground control compute device from the plurality of ground control compute devices is uniquely associated with an operator from the plurality of operators and the at least two unmanned vehicles uniquely associated with that operator. The mission management compute device is configured to automatically determine that an operator from the plurality of operators cannot perform a mission from the at least two missions associated with that operator and automatically reassign the mission that cannot be performed by the operator in response.

### FIELD

One or more embodiments are related to data processing of mission requests to automatically navigate unmanned vehicles.

### BACKGROUND

Unmanned vehicles (UVs) can be used in missions. UVs, though unmanned, may be operated by an operator. These operators, however, may not always operate missions as desired. For example, an operator may be assigned too many missions and perform missions poorly as a result. As another example, an operator's compute device may have a communication failure with a UV, leaving the UV unsupported. As another example, an operator may be inundated with information related to each mission, leading to decreased performance of the operator. Accordingly, it can be desirable that missions are properly assigned to operators, contingency plans are in place in case an operator cannot perform a mission, operators are not inundated with information that is not relevant at a given point in time, and/or the like.

### SUMMARY

In an embodiment, a non-transitory processor-readable medium stores code representing instructions to be executed by a processor. The instructions comprise code to cause the processor to automatically define, for each mission from a plurality of missions, a set of mission parameters based on a mission request for that mission and from a plurality of mission requests. The instructions further comprise code to cause the processor to automatically assign each mission from the plurality of missions to an operator from a plurality of operators based on an availability of that operator and a capacity of that operator. Each operator from the plurality of operators is associated with (1) at least one unmanned vehicle from the plurality of unmanned vehicles and (2) a ground control compute device from a plurality of ground control compute devices. The instructions further comprise code to cause the processor to, for each operator from the plurality of operators, automatically send a signal from a plurality of signals to a ground control compute device that is from the plurality of ground control compute devise and that is associated with that operator to initiate a set of missions from the plurality of missions that are assigned to that operator. The instructions further comprise code to cause the processor to, after a signal from the plurality of signals is sent, automatically determine that an operator from the plurality of operators cannot perform at least one mission from the set of missions assigned to the operator. The instructions further comprise code to cause the processor to automatically reassign the at least one mission in response to the determination that the operator cannot perform the at least one mission.

In an embodiment, a non-transitory processor-readable medium stores code representing instructions to be executed by a processor. The instructions comprise code to cause the processor to automatically receive, at a ground control compute device and from a mission management compute device, at least one mission signal that defines, for each mission from a plurality of missions for an operator of a plurality of unmanned vehicles, a set of mission parameters. The instructions further comprise code to cause the processor to receive, at the ground control compute device, from the operator, and after receiving the at least one mission signal, at least one input signal to initiate the plurality of missions. The instructions further comprise code to cause the processor to send, from the ground control compute device, at least one signal to the plurality of unmanned vehicles in response to receiving the at least one input signal. The instructions further comprise code to cause the processor to automatically filter, after initiating the plurality of missions and by the ground control compute device, information unrelated to execution of each mission from the plurality of missions while that mission is live. The instructions further comprise code to cause the processor to automatically output, by the ground control compute device, information related to the execution of each mission from the plurality of missions while that mission is live without outputting the information unrelated to the execution of each mission from the plurality of missions while that mission is live.

In an embodiment, a system comprises a mission management compute device configured to assign each mission from a plurality of missions to an operator from a plurality of operators. Each operator from the plurality of operators is uniquely associated with at least two unmanned vehicles from a plurality of unmanned vehicles. The system further comprises a plurality of ground control compute devices operatively coupled to the mission management compute device. Each ground control compute device from the plurality of ground control compute devices is uniquely associated with an operator from the plurality of operators and the at least two unmanned vehicles uniquely associated with that operator. The mission management compute device is configured to automatically determine that an operator from the plurality of operators cannot perform a mission from the at least two missions associated with that operator. The mission management compute device is configured to automatically reassign the mission that cannot be performed by the operator, in response to the determination that the operator cannot perform the mission.

### BRIEF DESCRIPTION OF THE DRAWINGS

FIG. 1 illustrates a system block diagram including a mission management compute device and multiple ground control compute devices for operating unmanned vehicles (UVs), according to an embodiment.

FIG. 2 illustrates an example of a graphical user interface (GUI) that includes avatars, according to an embodiment.

FIG. 3 shows a flowchart of a method to assign and reassign missions for operators, according to an embodiment.

FIG. 4 shows a flowchart of a method to receive missions and output information related to the execution of missions that are live, according to an embodiment.

### DETAILED DESCRIPTION

Some implementations described herein are related to defining mission parameters for missions and assigning those missions to operators. Each operator can then manage operation of one or more unmanned vehicles (UVs) to execute, based on the mission parameters, the mission(s) assigned to that operator. As missions are live, information related to execution of each mission can be output to operators, while information not related to execution of each mission is filtered out and not output to operators. Additionally, in response to an operator not being able to perform one or more missions, those one or more missions can be reassigned (e.g., to a different operator, to local control, and/or the like).

In some implementations, “mission parameters” refers to the parameters that a mission should and/or adheres to, such as such as the UV start point, UV end point, UV waypoints, time of mission, type of mission, UV(s) to be used, priority of that mission request (relative to other missions), security requirements, and/or the like. Examples of missions include delivering items (e.g., packages, groceries, mail, e-commerce products, etc.), capturing sensor data (e.g., photographs, temperature, air quality, terrain characteristics, etc.), performing military operations, conducting surveillance, conducting surveying, and/or the like.

Some implementations described herein manage operation of UVs without human intervention. For example, mission parameters for missions can be generated without human intervention based on mission requests, missions can be assigned without human intervention to operators, missions can be initiated without human intervention, a determination without human intervention can be made that an operator cannot perform a mission, missions can be reassigned without human intervention, information related to the execution of a mission can be output without human intervention, information not related to the execution of a mission can be filtered out without human intervention, and/or the like. By managing without human intervention all or parts of an UV's operation, at least some techniques described herein can be performed in real-time (e.g., at machine speed) and faster than if, for example, human intervention was involved; this can be useful in use cases where UVs are used to perform missions that are time sensitive, require confidentiality, where human resources are sparse (e.g., where the number of UVs greatly outnumber the qualified operators), and/or the like.

In other implementations, however, there can be human intervention, such as refraining from beginning an action until a human provides an indication to do so or using human input to modify input and/or output data. For example, mission parameters for missions can be generated and/or modified based on human intervention, missions can be assigned based on human intervention to operators, missions can be initiated based on human intervention, a determination can be made with human intervention that an operator cannot perform a mission, missions can be reassigned with human intervention, information related to the execution of a mission can be output with human intervention, information not related to the execution of a mission can be filtered out with human intervention, and/or the like.

In some implementations, techniques described herein are related to remotely managing operation of UVs. In some use cases, it can be desirable for UVs to be compact and/or light. By managing operation of UVs using compute devices remote from the UVs (e.g., mission management compute device, ground control compute devices, etc.) and offloading the hardware burden of UVs to the remote compute devices, the UV can be made more compact and/or light.

In some implementations, techniques described herein are related to assigning a better suited number of UVs to a given operator. This allows UVs to be more efficiently used. For example, if an operator is not assigned enough UVs for a given set of situations/missions, the operator may overly rely on assigned UVs to perform missions or not be able to complete missions. As another example, if an operator is assigned too many UVs, the operator may be overwhelmed or UVs may stay unused waiting for an operator's attention.

In some implementations where information not related to execution of each mission is filtered out and not output, a compute device can save power and reduce processing demands. This can be because, for example, the compute device does not execute commands to produce a notification for the unrelated information.

Some implementations are related to using a mobile device to control a UV. UVs are sometimes controlled by operators using mobile devices, such as if a solider is operating a UV on the battlefield or a scientist is using the UV in a non-laboratory setting to collect data. In such situations, using a smaller or portable compute device may be desirable.

Some implementations are related to presenting a limited amount of information on a limited screen. Some implementations are related to determining and/or causing display of a limited set of information, such as only information related to execution of a mission. Such limited set of information can be advantageous in some cases. For example, a user may not be able to view the entire set of data (e.g., both information related to execution of a mission and information not related to execution of the mission) using a compute device with a smaller screen, lesser processing power, lesser memory, and/or the like (such as some known mobile devices), but may be able to view the limited set of information (e.g., only information related to execution of the mission) using that compute device. As such, a user's efficiency and the compute device's efficiency can be improved (e.g., in analyzing the set of data to be analyzed) compared to known techniques.

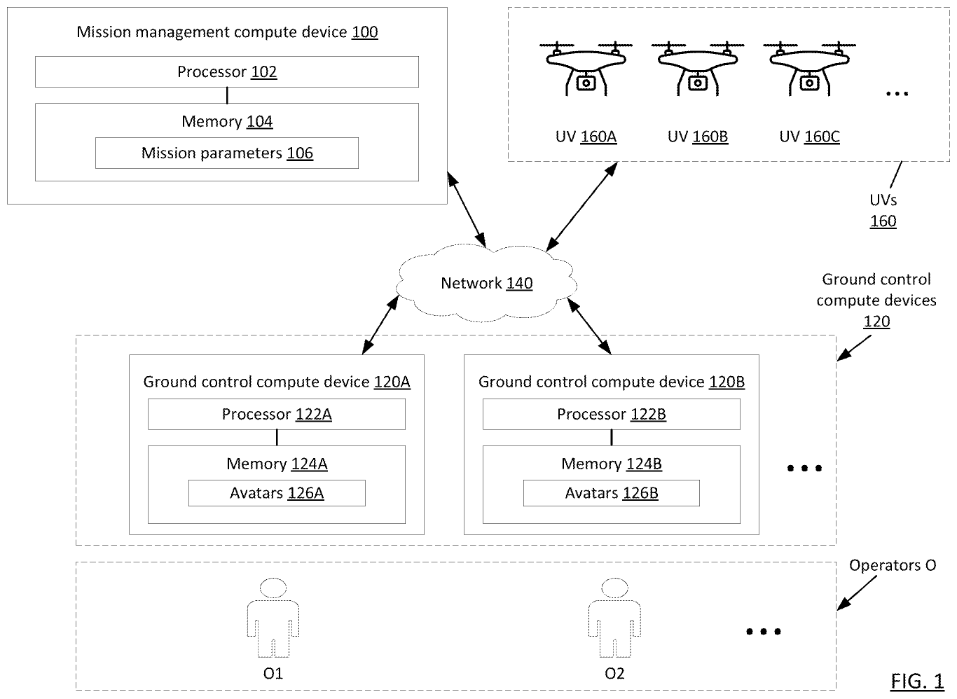

FIG. 1 illustrates a system block diagram including a mission management compute device and multiple ground control compute devices for operating unmanned vehicles (UVs), according to an embodiment. FIG. 1 includes mission management compute device 100, ground control compute devices 120, and UVs 160, each communicatively coupled to one another via network 140.

Network 140 can be any suitable communications network for transferring data, operating over public and/or private networks. For example, a network can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, network 140 can be a wireless network such as, for example, a Wi-Fi or wireless local area network (“WLAN”), a wireless wide area network (“WWAN”), and/or a cellular network. In other instances, network 140 can be a wired network such as, for example, an Ethernet network, a digital subscription line (“DSL”) network, a broadband network, and/or a fiber-optic network. In some instances, the network 140 can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via the network 140 can be encrypted or unencrypted. In some instances, network 140 can include multiple networks or subnetworks operatively coupled to one another by, for example, network bridges, routers, switches, gateways and/or the like.

In some implementations, network 140 is a private network. Thus, for example, only certain devices (such as mission management compute device 100, ground control compute device 120, UVs 160) can communicate via network 140. Using a private network can provide more security for, for example, controlling UVs 160. Since missions can often be critical, using a private network can prevent undesirable cyber-attacks.

Mission management compute device 100 can be any type of compute device, such as a server, desktop, laptop, tablet, phone, and/or the like. Mission management compute device 100 includes processor 102 operatively coupled to memory 104 (e.g., via a system bus).

Ground control compute devices 120 can include any number of ground control compute devices, such as ground control compute devices 120A, 120B, and/or the like. Each ground control compute device from ground control compute devices 120 can be any type of compute device, such as a server, desktop, laptop, tablet, phone, and/or the like. In some implementations, a ground control compute device from ground control compute devices 120 is a mobile device having a smaller screen, processing capability, memory capability, and/or the like compared to, for example, a tablet, laptop, desktop, or server. Each ground control compute device from ground control compute devices 120 can include a processor operatively coupled to a memory (e.g., via a system bus). For example, ground control compute device 120A includes processor 122A operatively coupled to memory 124A, ground control compute device 120B includes processor 122B operatively coupled to memory 124B.

Each ground control compute device from ground control compute devices 120 can be associated with (e.g., owned by, leased to, accessible by, in the name of, used by, etc.) an operator from operators O. Each operator from operators O can remotely manage and/or be tasked with remotely managing operation of one or more (e.g., multiple) UVs from UVs 160 assigned to that operator. The operator could be, for example, a drone pilot or air traffic controller. For example, ground control compute device 120A can be associated with operator O1 and ground control compute device 120B can be associated with operator O2.

UVs 160 can include any number of UVs, such as UVs 106A, 106B, 106C, and/or the like. In some implementations, UVs 160 are unmanned (e.g., no human is aboard the UV). In some implementations, UVs 160 are operated by one or more operators via one or more ground control compute devices from ground control compute devices 120. For example, UV 160A can be controlled by operator O1 via ground control compute device 120A over network 140, UVs 160B and 160C can be controlled by operator O2 via ground control compute devices 120B over network 140, and/or the like. UVs 160 can include any type of UV, such as an aerial UV, water UV, or ground UV. Examples of UVs 160 include semi-autonomous cars, manual cars, radio-controlled carts, radio-controlled aircraft, unmanned combat aerial vehicles, medium-altitude long-endurance unmanned aerial vehicles, miniature unmanned aerial vehicle (UAVs), delivery drones, micro air vehicles, target drones, spaceport drone ships, surface drones, underwater vehicles, uncrewed spacecrafts, and/or the like. In some implementations, each UV in UVs 160 is a UAV. The control of an UV by an operator can be, for example, full control (e.g., for a UV with not autonomy), partial control (e.g., for a UV with partial autonomy, and/or no autonomy during certain periods of time) and supervisory control (e.g., for a UV with a high level of autonomy that can be overtaken by the operator in certain situations such as emergency situations).

Although not explicitly shown in FIG. 1, each UV in UVs 160 can include a processor and memory. In some implementations, each UV in UVs 160 includes a camera and/or other sensors to track that UV's surroundings for consideration by the operator when operating that UV. In some implementations, UVs in UVs 160 have limited processing and/or memory capability due to, for example, a low weight requirement, a compact size requirement, and/or the like, and thus are operated remotely by one or more ground control compute devices from ground control compute devices 120.

Memory 104 of mission management compute device 100 can include (e.g., store) representation of mission parameters 106 for missions. Mission parameters 106 can represent parameters for missions that are to be completed by an operator(s) via that operator(s)'s associated ground control compute device and using one or more UVs from UVs 160. In some implementations, mission parameters 106 represents parameters that a mission should and/or adheres to, such as such as the UV start point, UV end point, UV waypoints, time of mission, type of mission, UV(s) to be used, priority of that mission request (relative to other missions), security requirements, and/or the like. Examples of missions include delivering items (e.g., packages, groceries, mail, e-commerce products, etc.), capturing sensor data (e.g., photographs, temperature, air quality, terrain characteristics, etc.), performing military operations, conducting surveillance, conducting surveying, and/or the like.

In some implementations, mission parameters 106 can be generated by mission management compute device 100 in response to receiving a representation of a mission request. In some implementations, a representation of a mission request is received at mission management compute device 100 from, for example, a requestor of the mission and/or the requestor's compute device (not shown in FIG. 1). For example, a buyer or seller of a good may use their compute device to generate and send an electronic signal to mission management compute device 100 and representing a mission request for sending or receiving that good via a drone to a specified location. As another example, a solider may use their compute device to generate and send an electronic signal to mission management compute device 100 representing a mission request for capturing video of a specified location. As another example, a user can provide input directly to mission management compute device 100 (e.g., using a mouse and/or keyboard) to provide a representation of a mission request. Accordingly, mission requests can be received at mission management compute device 100 via input at mission management compute device 100 from a user, an electronic signal representing the mission request from a remote compute device, and/or the like.

Each mission request can include information related to that mission request, such as the UV start point, UV end point, UV waypoints, time of mission, type of mission, UV(s) to be used, priority of that mission request (relative to other missions), security requirements, and/or the like. All or some of the information related to each mission request can be used by mission management compute device 100 to generate the mission parameter for the mission associated with that mission request. In some implementations, the mission request can include an indication of the service to be rendered at the destination, and generating the mission parameters based on the mission request can include receiving the associated standard operating procedure (SOP) for the destination from a repository of pre-defined flight plans. In some implementations, all information included in a mission request for a mission are used to generate the mission parameters for that mission. In some implementations, only a portion of the information included in a mission request for a mission is used to generate the mission parameters for that mission.

In some implementations, a machine learning model can be used to generate mission parameters 106 based on mission requests. In some implementations, the machine learning model is trained using mission requests as input learning data and mission parameters as output learning data. In some implementations, mission parameters 106 are generated without human intervention based on mission requests. For example, mission management compute device 100 can automatically (e.g., without human intervention) generate mission parameters for a mission in response to receiving a mission request.

In some implementations, in response to the machine learning model generating mission parameters for a mission in response to a mission request, feedback can be provided to the machine learning model (e.g., from a user, from a different machine learning model, and/or the like) for retraining the machine learning model, such as whether the mission parameters are well generated or not. In some implementations, this can result in a more accurate machine learning model.

In some implementations, mission parameters 106 can include sets of mission parameters, and each set of mission parameters can be associated with a given mission. Mission parameters 106 can include details of the missions, such as the flight path, UV to be used, start time of the mission, end time of the mission, waypoints within the flight path, and/or the like. In some implementations, mission parameters 106 can include planned mission volumes that are representations of geofenced flight volumes that define the planned performance volumes for execution of the missions. In some implementations, mission parameters 106 can include contingency volumes that represent geofenced flight volumes surrounding the planned mission volumes consisting of predetermined areas for the UVs to navigate to, as part of a contingency response activated to mitigate an unexpected event during mission execution.

Mission parameters 106 can include sets of mission parameters, and each set of mission parameters can be associated with a given mission that mission management compute device 100 is configured to assign to an operator from operators O. Said differently, mission management compute device 100 can be configured to assign the missions associated with mission parameters 106 to operators from operators O. Operators can be assigned to manage operation of a single UV from UVs 160, multiple UVs from UVs 160, or a combination thereof. For example, if mission parameters 106 includes mission parameters for a first mission, a second mission, and a third mission, operator O1 can be assigned to complete the first mission and operator O2 can be assigned to complete the second mission and the third mission. In some implementations, mission management compute device 120 can be configured to assign each mission represented by mission parameters 106 to an operator from operators O automatically (e.g., without human intervention) in response to generating missions 106. Mission management compute device 100 may include a database (e.g., within memory 104 or within a memory/storage device external from mission management compute device 100) that stores an indication(s) of what missions are assigned to what operators.

In some implementations, mission management compute device 120 can be configured to assign each mission from missions associated with mission parameters 106 to an operator from operators O based on an availability (e.g., if currently online or offline, if scheduled to work soon or get off soon, etc.) of that operator, a capacity (e.g., number of UVs that operator is already operating, number of UVs that operator is already operating relative to a predetermined upper limit of UVs that operator can operate, etc.) of that operator, a skill of that operator, an experience with a site for that operator, an experience level of that operator, role based access controls, and/or the like. In some implementations, missions can be assigned to operators according to techniques described in U.S. patent application Ser. No. 18/393,368, filed Dec. 21, 2023 and titled “SYSTEMS AND METHODS TO EFFICIENTLY NAVIGATE UNMANNED VEHICLES,” the contents of which are incorporated by reference herein in its entirety.

After generating mission parameters 106 and assigning operators to missions, mission management compute device 120 can also be configured to send an electronic signal(s) (e.g., mission signal) to ground control compute devices 120 and indicating the mission(s) assigned to a ground control compute device's associated operator and/or each ground control compute device's associated operator, along with the mission parameters for that assigned mission(s). For example, if operator O1 is assigned to complete to a first mission and operator O2 is assigned to complete a second mission and a third mission, mission management compute device 100 can send an electronic signal (e.g., mission signal) to ground control compute device 120A indicating that operator O1 is assigned the first mission (along with a representation of the mission parameters for the first mission) and send an electronic signal (e.g., mission signal) to ground control compute device 120B indicating that operator O2 is assigned the second mission and the third mission (along with a representation of the mission parameters for the second mission and the third mission).

After mission parameters 106 have been provided and/or missions have been assigned to ground control compute devices 120, each ground control compute device from ground control compute devices 120 can receive an indication(s) to initiate the mission(s) assigned to the operator associated with that ground control compute device. An indication(s) to initiate the mission(s) can be, for example, receiving a first electronic signal from mission management compute device 100 with the assigned mission(s) and/or mission parameters (i.e., receiving an indication(s) of the mission(s) and/or mission parameters automatically initiates the mission), receiving a second electronic signal from mission management compute device 100 after the first electronic signal indicating that the mission(s) can start, receiving an input from an operator that the mission(s) can start, and/or the like.

Once a given mission has been initiated, the ground control compute device(s) assigned to that mission can send an electronic signal(s) to a UV(s) to control operation of the UV(s) from UVs 160. For example, in response to ground control compute device 120A receiving an indication from operator O1 to initiate a mission, ground control compute device 120A can send an electronic signal to UV 160A and operator O1 can control operation of the UV 160A using ground control compute device 120A to perform the mission. Controlling operation could include, for example, manually operating the UV, monitoring the UV as the UV operates autonomously/semi-autonomously, and/or the like.

In some implementations, for each mission from missions 106 that is live (e.g., active, currently being performed), information related to execution of that mission and/or information that is not related to execution of that missions can be determined. Examples of information that may be related to execution of a mission in one use case (but might not necessarily be considered related in other a different use case) could be, for example, location of obstacles, weather conditions (e.g., wind condition, weather emergencies, etc.), UV malfunction, traffic, and/or the like.

In some implementations, what information that is to be considered related or not related to execution of a mission is determined before the mission is live and/or while the mission is live. For example, the operator assigned the mission can select (e.g., using their ground control compute device) from a predetermined list what information is related and/or what information that is not related. As another example, a machine learning model can produce an output indicating whether information is related is not; the machine learning model could be, for example, a neural network trained using information from missions (e.g., a past mission, a synthetically generated mission, and/or the like.) and whether information was relevant or not for an associated mission.

In some implementations, information related to the execution of a mission while that mission is live can be output, for example, at a user interface and/or in the form of a notification (e.g., at mission management compute device 100 and/or ground control compute devices 120). Information related to the execution of a mission while that mission is live can be output using various techniques such as, for example, visual output on a display, a haptic notification (e.g., vibration), a sound notification, and/or the like. In some implementations, information not related to the execution of a mission while that mission is live is not output (e.g., no notifications). To provide an example, if snow or nearby drones are information related to execution of a mission assigned to operator O1 and ground control compute device 120A, but rain is not information related to execution of that mission, the presence of snow or a nearby drone can cause ground control compute device 120A to provide a notification indicating such presence to operator O1, while the presence of rain does not cause a notification to be output. In some implementations, the type of notification that is output can depend on the type of information that is related to the execution of the mission, such as a first type of notification (e.g., sound) for a first type of information (e.g., snowing), a second type of notification (e.g., vibration) for a second type of information (e.g., other drones nearby), and/or the like.

In some implementations, all missions and/or only a subset of missions assigned to an operator can be reassigned in response to determining that the operator cannot perform the mission(s). If only a subset of missions from a set of missions assigned to an operator are reassigned, the operator can remain assigned to the remaining missions from the set of missions. To provide an example, if operator O1 is assigned a first mission with UV 160A and a second mission with UV 160B, and a communication failure occurs between ground control compute device 120A and both UVs 160A and 160B, the first mission, and/or second mission can be reassigned elsewhere (e.g., operator O2, mission management compute device 100 for local control, etc.). To provide another example, if operator O1 is assigned a first mission with UV 160A and a second mission with UV 160B, and a communication failure occurs between ground control compute device 120A and UV 160A but not UV 160B, the first mission and/or UV 160A can be reassigned elsewhere (e.g., operator O2, mission management compute device 100 for local control, etc.) while the second mission and/or UV 160B remain assigned to operator O1. In some implementations, a mission and/or UV can be reassigned to a different operator if possible, and if not possible then to local control/mission management compute device 100. For example, a determination can be made as to whether a given operator can and/or should be assigned a mission and/or UV based on the operator's availability and/or capacity. If, for example, the operator is offline or already assigned a number of missions and/or UVs greater than a predetermined threshold for that operator, the mission and/or UV can be assigned to mission management compute device 100 for local control. If, however, the operator is online or not yet assigned a number of missions and/or UVs greater than a predetermined threshold for that operator, the mission and/or UV can be assigned to operator.

The operator might not be able to perform the mission(s) for any reason, such as a communication failure between the operator's ground control compute device, mission management compute device 100 and/or UV, the operator is sick, the operator's ground control compute device turned off, the operator is assigned too many missions or UVs, and/or the like. In some implementations, a communication failure can be identified based on, for example, a loss of connection at a UV, mission management compute device, and/or ground control compute device, a loss of power at the UV, mission management compute device, and/or ground control compute device, not receiving a signal within a predetermined signal of time at the UV, mission management compute device, and/or ground control compute device, an input provided by the operator via their ground control compute device, an electronic signal from the UV, operator's ground control compute device, and/or third party (e.g., network provider), and/or the like. In some implementations, an operator can provide input to their associated ground control compute device indicating that they cannot perform a mission(s) (e.g., they are sick, they need to take a break, they lost connection to a UV, etc.), and the ground control compute device can send an electronic signal to mission management compute device 100 indicating so.

The mission(s) can be reassigned to a different operator, local control, and/or the like. In some implementations, if the mission(s) is assigned to a different operator, the number of missions and/or UVs associated with that different operator does not exceed a predetermined number of missions and/or UVs for that different operator (e.g., as discussed in U.S. patent application Ser. No. 18/393,368, filed Dec. 21, 2023 and titled “SYSTEMS AND METHODS TO EFFICIENTLY NAVIGATE UNMANNED VEHICLES,” the contents of which are incorporated by reference herein in its entirety). In some implementations, local control can refer to mission management compute device 100 controlling operation of a UV without human intervention (e.g., auto-pilot).

Each ground control compute device from ground control compute devices 120 can include (e.g., store in memory) representation of one or more avatars. For example, memory 124A can store avatars 126A, memory 124B can store avatars 126B, and/or the like. Additionally, in some implementations, each operator is associated with (e.g., assigned to manage operation of) a set of one or more UVs (e.g., only one UV, multiple UVs). For example, operator O1 is associated with a first UV and operator O2 is associated with a second UV and a third UV. In some implementations, each UV from the set of UVs is associated with (e.g., represented by) a unique avatar from a plurality of avatars, and each avatar from the plurality of avatars is uniquely associated with a UV from the set of UVs. For example, if operator O1 is associated with (assigned to) a first UV and operator O2 is associated with (assigned to) a second UV and a third UV, avatars 126A can include an avatar associated with the first UV, avatars 126B can include an avatar associated with the second UV, and avatars 126B can include an avatar associated with the third UV. An avatar could be or include, for example, an image, text, video, and/or the like.

In some implementations, an avatar can be associated with (e.g., represent) a UV, and the avatar can be a representation (e.g., icon or image) displayed on a display of a ground control compute device so that the operator has a sense on a map as to the UV's location based on the avatar's location on the map. For example, if operator O1 is assigned missions using UVs 160A and 160B, avatars 126A can include a first avatar representing UV 160A's location on a map and a second avatar representing UV 160B's current location on a map (e.g., on a display of ground control compute device 120A). Additionally or alternatively, other information and/or commands associated with a UV can be represented via an avatar, such as relevant information for live missions, command and control options (e.g., operate UV semi-autonomously, operate UV fully autonomously, etc.), options to abort a mission, and/or the like.

In some implementations, avatars can be output (e.g., displayed) at ground control compute devices. For example, avatars 126A can be displayed at ground control compute device 120A and avatars 126B can be displayed at ground control compute device 120B. As another example, in some implementations, information related to the execution of a mission while that mission is live is represented as an avatar. If, for example, operator O1 is assigned a first UV associated with a first avatar from avatars 126A for a first mission, operator O2 is assigned a second UV associated with second avatar from avatars 126B for a second mission, and operator O3 is assigned a third UV associated with a third avatar from avatars 126B for a third mission, information related to the execution of the first mission can be output at ground control compute device 120A via the first avatar, information related to the execution of the second mission can be output at ground control compute device 120B via the second avatar, and information related to the execution of the third mission can be output at ground control compute device 120B via the third avatar.

In some implementations, an avatar can be selected (e.g., by an associated operator selecting the avatar and/or something associated with the avatar) to command and control the UV associated with that avatar. This can cause, for example, the UV associated with that avatar to operate at least semi-autonomously. For example, if operator O1 selects an avatar from avatars 126A associated with a UV and/or an icon associated with the avatar representing a commend to control and command, ground control compute device 120A can command and control (e.g., operate at least semi-autonomously) that UV at least semi-autonomously and/or send an electronic signal to a different compute device (e.g., mission management compute device 100) to command and control that UV at least semi-autonomously.

In some implementations, a determination is made (e.g., automatically without human intervention), via an avatar, that an operator cannot perform a mission associated with (e.g., assigned to be conducted using a UV represented by) the avatar. For example, an operator can select the avatar and/or an icon associated with the avatar using their ground control compute device, and provide an indication that the operator cannot control the UV associated with that avatar and/or the mission associated with that UV cannot be completed. In response (e.g., automatically and without human intervention), the mission can be managed by, for example, a different compute device (e.g., mission management compute device 100, a different ground control compute device, and/or the like).

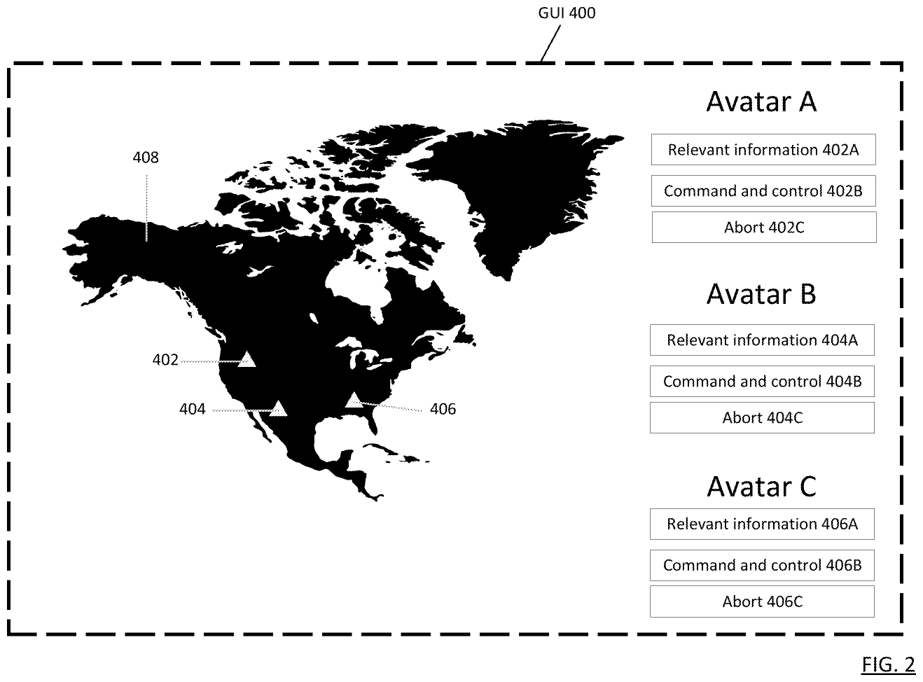

FIG. 2 illustrates an example of a graphical user interface (GUI) 400 that includes avatars, according to an embodiment. In some implementations, GUI 400 can be displayed at a ground control compute device (e.g., from ground control compute devices 120).

GUI 400 includes map 408 and avatars 402, 404, 406 (e.g., similar to avatar 126A of FIG. 1). Each avatar 402, 404, 406 can represent a different UV. For example, avatar 402 can digitally represent a first UV (e.g., UV 160A from FIG. 1), avatar 404 can digitally represent a second UV different than the first UV (e.g., UV 160B from FIG. 1), and avatar 406 can digitally represent a third UV different than the first UV and second UV (e.g., UV 160C from FIG. 1).

In some implementations, all avatars shown in GUI 400 represents all UVs for missions assigned to an operator. For example, avatars 402, 404, 406 can represent UVs for missions assigned to operator O1 (but not operator O2). As a UV progresses through a mission, the real-time location of the UV can be represented via the avatar at map 408; for example, avatar 402 can represent the location of a UV represented by avatar 402 on map 408 of GUI 400, avatar 404 can represent the location of a UV represented by avatar 404 on map 408 of GUI 400, and avatar 406 can represent the location of a UV represented by avatar 406 on map 408 of GUI 400.

GUI 400 additionally includes a representation of icons for each avatar; for avatar 402, GUI 400 includes icons for relevant information 402A, command and control 402B, and abort 402C; for avatar 404, GUI 400 includes icons for relevant information 404A, command and control 404B, and abort 404C; and for avatar 406, GUI 400 includes icons for relevant information 406A, command and control 406B, and abort 406C.

If an operator selects a relevant information icon for an avatar, relevant information associated with the UV (e.g., while a mission performed by the UV is live) represented by the avatar can be output at GUI (while irrelevant information is not). For example, relevant information for avatar 402 can be output at GUI 400 if an operator selects relevant information 402A, relevant information for avatar 404 can be output at GUI 400 if an operator selects relevant information 404A, and relevant information for avatar 406 can be output at GUI 400 if an operator selects relevant information 406A.

If an operator selects a command and control icon for an avatar, the UV associated with that avatar can be caused to operate at least semi-autonomously. For example, the UV represented by avatar 402 can be caused to operate at least semi-autonomously if an operator selects command and control 402B, the UV represented by avatar 404 can be caused to operate at least semi-autonomously if an operator selects command and control 404B, and the UV represented by avatar 406 can be caused to operate at least semi-autonomously if an operator selects command and control 406B.

If operator selects an abort icon for an avatar, the mission being performed by the UV represented by the avatar can be aborted (e.g., cancel the mission, reassign the mission to a different operator, assign the mission to local command, and/or the like). For example, the mission being performed by a UV represented by avatar 402 can be aborted if an operator selects abort 402C, the mission being performed by a UV represented by avatar 404 can be aborted if an operator selects abort 404C, and the mission being performed by a UV represented by avatar 406 can be aborted if an operator selects abort 406C.

### System

In an embodiment, a system includes a mission management compute device (e.g., mission management compute device 100) configured to assign each mission from a plurality of missions (e.g., missions 106) to an operator from a plurality of operators (e.g., O1, O2, etc.). Each operator from the plurality of operators can be uniquely associated with at least two unmanned vehicles from a plurality of unmanned vehicles. The system can further include a plurality of ground control compute devices (e.g., ground control compute devices 120) operatively coupled to the mission management compute device. Each ground control compute device from the plurality of ground control compute devices can be uniquely associated with an operator from the plurality of operators and the at least two unmanned vehicles can be uniquely associated with that operator. The mission management compute device can be configured to automatically determine that an operator from the plurality of operators cannot perform a mission from the at least two missions associated with that operator. The mission management compute device can also be configured to automatically reassign the mission that cannot be performed by the operator, in response to the determination that the operator cannot perform the mission.

In some implementations, the mission management compute device is configured to automatically reassign the mission that cannot be performed by the operator to the mission management compute device. The mission management compute device can be further configured to automatically manage the mission after the mission is reassigned.

In some implementations, the operator is a first operator and the mission management compute device is configured to automatically reassign the mission that cannot be performed by the operator to a second operator from the plurality of operators.

In some implementations, each ground control compute device from the plurality of ground control compute devices is configured to automatically filter information unrelated to execution of each mission from the at least two missions associated with the operator for that ground control compute device while that mission is live. Each ground control compute device from the plurality of ground control compute devices can be configured to automatically output information related to execution of each mission from the at least two missions associated with the operator for that ground control compute device while that mission is live.

In some implementations, each ground control compute device from the plurality of ground control compute devices is configured to receive, via an avatar from a plurality of avatars (e.g., avatars 126A, 126B, etc.), an indication to command and control (C2) the unmanned vehicle uniquely associated with that avatar and from the at least two unmanned vehicles for the operator associated with that ground control compute device. Each ground control compute device from the plurality of ground control compute devices can be configured to automatically determine, via the avatar associated with that ground control compute device, that the operator for that ground control compute device cannot perform a mission from the at least two missions for that operator. Each ground control compute device from the plurality of ground control compute devices can be configured to automatically manage, via the avatar associated with that ground control compute device, the mission in response to the determination that the operator cannot perform the mission.

### Methods

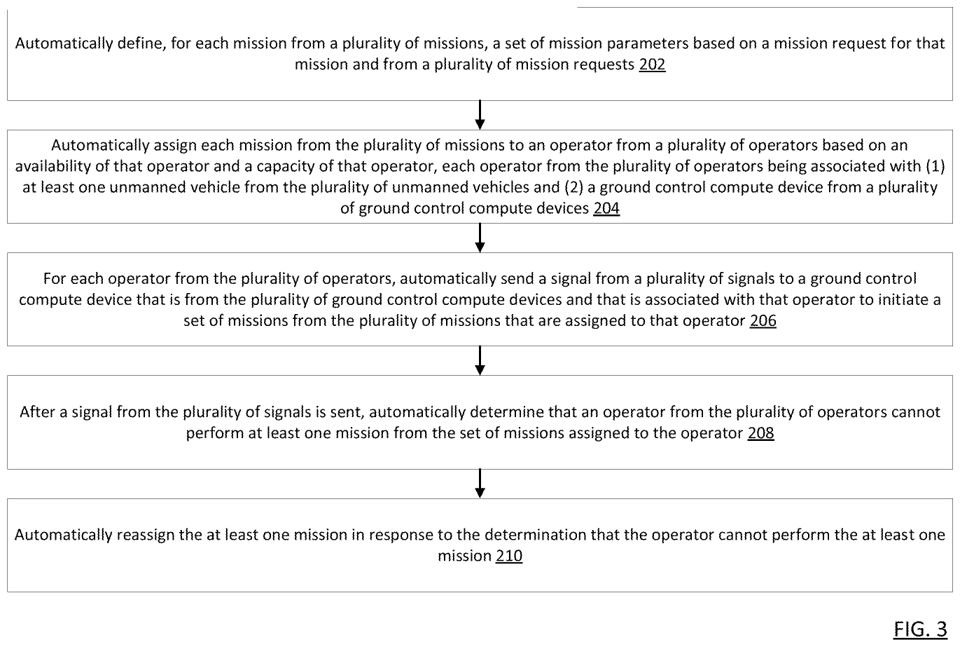

FIG. 3 shows a flowchart of a method 200 to assign and reassign missions for operators, according to an embodiment. In some implementations, method 200 is performed by a processor (e.g., processor 102).

At 202, for each mission from a plurality of missions, a set of mission parameters (e.g., included in mission parameters 106) are automatically (e.g., without human intervention) defined based on a mission request for that mission and from a plurality of mission requests. At 204, each mission from the plurality of missions is automatically (e.g., without human intervention) assigned to an operator from a plurality of operators (e.g., operators O1, O2) based on an availability of that operator and a capacity of that operator. Each operator from the plurality of operators is associated with (1) at least one unmanned vehicle from the plurality of unmanned vehicles (e.g., UVs 160) and (2) a ground control compute device from a plurality of ground control compute devices (e.g., ground control compute devices 120). At 206, for each operator from the plurality of operators, a signal from a plurality of signals is automatically (e.g., without human intervention) sent to a ground control compute device that is from the plurality of ground control compute devices and that is associated with that operator to initiate a set of missions from the plurality of missions that are assigned to that operator. At 208, after a signal from the plurality of signals is sent, an operator from the plurality of operators that cannot perform at least one mission from the set of missions assigned to the operator is automatically (e.g., without human intervention) determined. At 210, the at least one mission is automatically (e.g., without human intervention) reassigned in response to the determination that the operator cannot perform the at least one mission.

In some implementations of method 200, the at least one mission is automatically (e.g., without human intervention) reassigned to local control at 210 in response to the determination at 208 that the operator cannot perform the at least one mission. Some implementations of method 200 further include automatically (e.g., without human intervention) managing the at least one mission initially assigned to the operator, in response to the at least one mission being reassigned to local control.

In some implementations of method 200, the operator is a first operator and automatically reassigning at 210 includes automatically (e.g., without human intervention) reassigning the at least one mission associated with the first operator to a second operator from the plurality of operators in response to the determination that the first operator cannot perform the at least one mission at 208.

In some implementations of method 200, automatically assigning at 204 includes automatically (e.g., without human intervention) assigning at least two missions from the plurality of missions to a common operator from the plurality of operators.

In some implementations of method 200, automatically sending at 206 includes automatically (e.g., without human intervention) sending at least two signals from the plurality of signals to a common ground control compute device from the plurality of ground control compute devices. Sending two signals to the common ground control compute device could include, for example, a first signal assigning a first UV for a first mission associated with the common ground control compute device and a second signal assigning a second UV for a second mission associated with the common ground control compute device.

In some implementations of method 200, automatically determining at 208 includes automatically (e.g., without human intervention) determining that the operator cannot perform a first mission from the set of missions and the operator can perform a second mission from the set of missions. The automatically reassigning at 210 can then include automatically (e.g., without human intervention) reassigning the first mission and not reassigning the second mission.

In some implementations of method 200, the at least one mission associated with the operator includes at least two missions, automatically determining at 208 includes automatically (e.g., without human intervention) determining that the operator cannot perform any of the at least two missions associated with the operator, and automatically (e.g., without human intervention) reassigning at 210 includes automatically reassign every mission from the at least two missions.

Some implementations of method 200 further include simultaneously displaying within a user interface a representation of each live mission from the plurality of missions. For example, a display of ground control compute device 120A for operator O1 can display within a user interface (e.g., GUI 400) for a given time period a representation of each live mission (e.g., displaying an avatar for each UV actively operating to conduct a respective mission within the given time period).

In some implementations of method 200, the operator is a first operator and method 200 further includes receiving an indication of communication failure between a ground control compute device from the plurality of ground control compute devices associated with the first operator and a first unmanned vehicle from a plurality of unmanned vehicles assigned to the first operator. Automatically reassigning at 210 can include automatically (e.g., without human intervention), in response to the receiving the indication of communication failure, reassigning the first unmanned vehicle to a second operator from the plurality of operators based on an availability of the second operator. A non-zero number of unmanned vehicles assigned to the second operator after the first unmanned vehicle is reassigned to the second operator does not exceed an upper limit of unmanned vehicles for the second operator.

In some implementations of method 200, the operator is a first operator and method 200 further include receiving an indication of communication failure between a ground control compute device from the plurality of ground control compute devices associated with the first operator and a first unmanned vehicle from a plurality of unmanned vehicles assigned to the first operator. Automatically reassigning at 210 can include automatically (e.g., without human intervention), in response to the receiving the indication of communication failure, reassigning the at least one unmanned vehicle associated with the first operator and including the first unmanned vehicle to at least one operator other than the first operator and from the plurality of operators based on an availability of the at least one operator. A non-zero number of unmanned vehicles assigned to each operator from the least one operator after the plurality of unmanned vehicles associated with the first operator does not exceed an upper limit of unmanned vehicles for each operator from the least one operator.

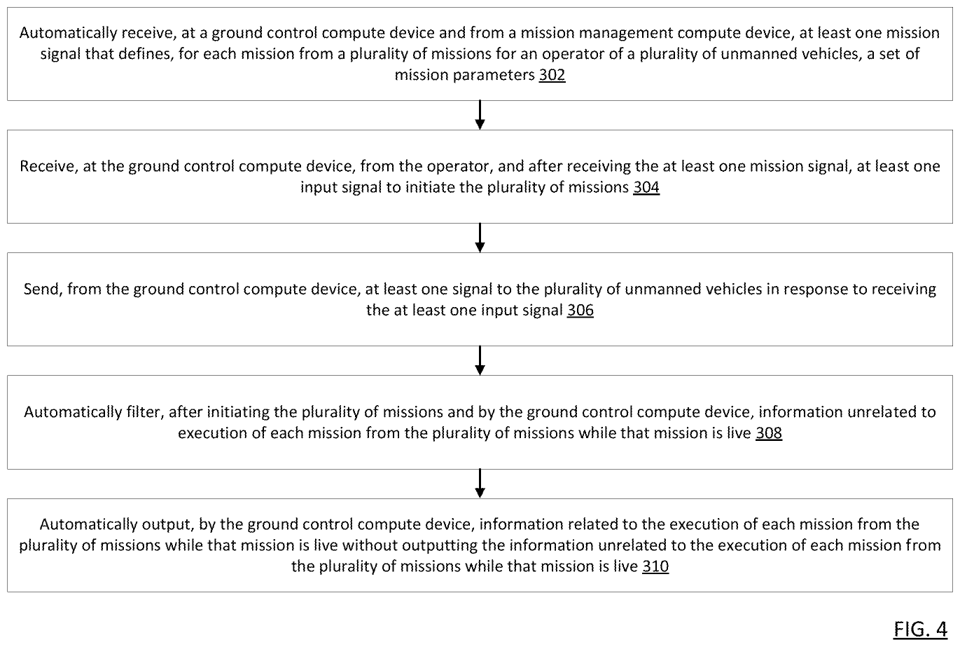

FIG. 4 shows a flowchart of a method 300 to receive missions and output information related to the execution of missions that are live, according to an embodiment. In some implementations, method 300 is performed by a processor (e.g., processor 122A or 122B).

At 302, at least one mission signal that defines, for each mission from a plurality of missions for an operator of a plurality of unmanned vehicles (e.g., UVs 160), a set of mission parameters (e.g., included in mission parameters 106) is automatically (e.g., without human intervention) received at a ground control compute device (e.g., from ground control compute devices 120) and from a mission management compute device (e.g., mission management compute device 100). At 304, at least one input signal to initiate the plurality of missions is received at the ground control compute device, from the operator, and after receiving the at least one mission signal at 302. At 306, at least one signal is sent, from the ground control compute device, to the plurality of unmanned vehicles in response to receiving the at least one input signal at 304. At 308, information unrelated to execution of each mission from the plurality of missions while that mission is live is automatically (e.g., without human intervention) filtered after initiating the plurality of missions and by the ground control compute device. At 310, information related to the execution of each mission from the plurality of missions while that mission is live is automatically (e.g., without human intervention) output by the ground control compute device without outputting the information unrelated to the execution of each mission form the plurality of missions while that mission is live.

In some implementations of method 300, the information related to the execution of each mission from the plurality of missions is a notification to the operator for that mission. The notification can be automatically (e.g., without human intervention) output to the operator for each mission from the plurality of missions. Automatically filtering at 308 can include preventing a notification unrelated to the execution of each mission from the plurality of missions to be output.

In some implementations of method 300, the information related to the execution of each mission from the plurality of missions is a notification to the operator for that mission and automatically outputting at 310 includes automatically (e.g., without human intervention) outputting a signal to an external device that provides to the operator an auditory or haptic notification for each mission from the plurality of missions. For example, the ground control compute device can send an electronic signal to a mission management compute device and/or different compute device; in response to receiving the electronic signal, the mission management compute device and/or different compute device can produce the auditory or haptic notification (via a haptic actuator or an audio speaker). The auditory or haptic notification can be, for example, sound describing the information related to the execution, a vibration indicating the information related to the execution, and/or the like.

In some implementations of method 300, the at least one mission signal includes a first mission signal that defines a first set of mission parameters for a first mission from the plurality of missions and a second mission signal that defines a second set of mission parameters for a second mission from the plurality of missions. The first mission can be assigned to a first unmanned vehicle from the plurality of unmanned vehicles, and the second mission can be assigned to a second unmanned vehicle from the plurality of unmanned vehicles.

In some implementations of method 300, automatically outputting at 310 includes automatically (e.g., without human intervention) outputting, to a user interface, the information related to the execution of each mission from the plurality of missions. The information related to the execution of each mission from the plurality of missions can be a representation of an avatar from a plurality of avatars (e.g., avatars 126A or 126B). Each unmanned vehicle from the plurality of unmanned vehicles can be uniquely associated with an avatar from the plurality of avatars.

In some implementations of method 300, each avatar from the plurality of avatars is uniquely associated with an unmanned vehicle from the plurality of unmanned vehicles, and method 300 further includes, for each avatar from the plurality of avatars, receiving an indication, via that avatar, to command and control (C2) the unmanned vehicle uniquely associated with that avatar and from the plurality of unmanned vehicles.

Some implementations of method 300 further include, for each avatar from a plurality of avatars (e.g., avatars 126A or 126B), receiving an indication, via that avatar, to command and control (C2) the unmanned vehicle uniquely associated with that avatar and from the plurality of unmanned vehicles. Some implementations further include automatically (e.g., without human intervention) determining, via a first avatar from the plurality of avatars, that the operator cannot perform a first mission from the plurality of missions. The first avatar can be uniquely associated with the first mission. Some implementations further include automatically (e.g., without human intervention) managing, via the first avatar, the first mission in response to the determination that the operator cannot perform the first mission.

All combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments and unless stated otherwise, the terms “about” “substantially” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure.

1. A non-transitory processor-readable medium storing code representing instructions to be executed by a processor, the instructions comprising code to cause the processor to:
automatically define, for each mission from a plurality of missions, a set of mission parameters based on a mission request for that mission and from a plurality of mission requests;
automatically assign each mission from the plurality of missions to an operator from a plurality of operators based on an availability of that operator and a capacity of that operator, each operator from the plurality of operators being associated with (1) at least one unmanned vehicle from the plurality of unmanned vehicles and (2) a ground control compute device from a plurality of ground control compute devices;
for each operator from the plurality of operators, automatically send a signal from a plurality of signals to a ground control compute device that is from the plurality of ground control compute devices and that is associated with that operator to initiate a set of missions from the plurality of missions that are assigned to that operator;
after a signal from the plurality of signals is sent, automatically determine that an operator from the plurality of operators cannot perform at least one mission from the set of missions assigned to the operator; and
automatically reassign the at least one mission in response to the determination that the operator cannot perform the at least one mission.

2. The non-transitory processor-readable medium of claim 1, wherein the code to automatically reassign include code to automatically reassign the at least one mission to local control, in response to the determination that the operator cannot perform the at least one mission, the instructions further comprising code to cause the processor to:
automatically manage the at least one mission initially assigned to the operator, in response to the at least one mission being reassigned to local control.

3. The non-transitory processor-readable medium of claim 1, wherein:
the operator is a first operator,
the code to automatically reassign include code to automatically reassign the at least one mission associated with the first operator to a second operator from the plurality of operators, in response to the determination that the first operator cannot perform the at least one mission.

4. The non-transitory processor-readable medium of claim 1, wherein the code to automatically assign includes code to further cause the processor to automatically assign at least two missions from the plurality of missions to a common operator from the plurality of operators.

5. The non-transitory processor-readable medium of claim 1, wherein the code to automatically send includes code to further cause the processor to automatically send at least two signals from the plurality of signals to a common ground control compute device from the plurality of ground control compute devices.

6. The non-transitory processor-readable medium of claim 1, wherein:
the code to automatically determine includes code to automatically determine that the operator cannot perform a first mission from the set of missions and the operator can perform a second mission from the set of missions, and
the code to automatically reassign includes code to automatically reassign the first mission and not reassign the second mission.

7. The non-transitory processor-readable medium of claim 1, wherein:
the at least one mission associated with the operator includes at least two missions,
the code to automatically determine includes code to automatically determine that the operator cannot perform any of the at least two missions associated with the operator, and
the code to automatically reassign includes code to automatically reassign every mission from the at least two missions.

8. The non-transitory processor-readable medium of claim 1, further comprising code to cause the processor to:
simultaneously display within a user interface a representation of each live mission from the plurality of missions.

9. The non-transitory processor-readable medium of claim 1, wherein the operator is a first operator, the non-transitory processor-readable medium further comprises code to cause the processor to:
receive an indication of communication failure between a ground control compute device from the plurality of ground control compute devices associated with the first operator and a first unmanned vehicle from a plurality of unmanned vehicles assigned to the first operator,
the code to automatically reassign include code to automatically, in response to the receiving the indication of communication failure, reassign the first unmanned vehicle to a second operator from the plurality of operators based on an availability of the second operator,
a non-zero number of unmanned vehicles assigned to the second operator after the first unmanned vehicle is reassigned to the second operator does not exceed an upper limit of unmanned vehicles for the second operator.

10. The non-transitory processor-readable medium of claim 1, wherein the operator is a first operator, the non-transitory processor-readable medium further comprises code to cause the processor to:
receive an indication of communication failure between a ground control compute device from the plurality of ground control compute devices associated with the first operator and a first unmanned vehicle from a plurality of unmanned vehicles assigned to the first operator,
the code to automatically reassign include code to automatically, in response to the receiving the indication of communication failure, reassign the at least one unmanned vehicle associated with the first operator and including the first unmanned vehicle to at least one operator other than the first operator and from the plurality of operators based on an availability of the at least one operator,
a non-zero number of unmanned vehicles assigned to each operator from the least one operator after the plurality of unmanned vehicles associated with the first operator does not exceed an upper limit of unmanned vehicles for each operator from the least one operator.

11. A non-transitory processor-readable medium storing code representing instructions to be executed by a processor, the instructions comprising code to cause the processor to:
automatically receive, at a ground control compute device and from a mission management compute device, at least one mission signal that defines, for each mission from a plurality of missions for an operator of a plurality of unmanned vehicles, a set of mission parameters;
receive, at the ground control compute device, from the operator, and after receiving the at least one mission signal, at least one input signal to initiate the plurality of missions;
send, from the ground control compute device, at least one signal to the plurality of unmanned vehicles in response to receiving the at least one input signal;
automatically filter, after initiating the plurality of missions and by the ground control compute device, information unrelated to execution of each mission from the plurality of missions while that mission is live; and
automatically output, by the ground control compute device, information related to the execution of each mission from the plurality of missions while that mission is live without outputting the information unrelated to the execution of each mission from the plurality of missions while that mission is live.

12. The non-transitory processor-readable medium of claim 11, wherein:
the information related to the execution of each mission from the plurality of missions is a notification to the operator for that mission,
the code to automatically output includes code to automatically output the notification to the operator for each mission from the plurality of missions,
the code to automatically filter includes code to prevent a notification unrelated to the execution of each mission from the plurality of missions to be output.

13. The non-transitory processor-readable medium of claim 11, wherein:
the information related to the execution of each mission from the plurality of missions is a notification to the operator for that mission,
the code to automatically output includes code to automatically output a signal to an external device that provides to the operator an auditory or haptic notification for each mission from the plurality of missions.

14. The non-transitory processor-readable medium of claim 11, wherein:
the at least one mission signal includes a first mission signal that defines a first set of mission parameters for a first mission from the plurality of missions and a second mission signal that defines a second set of mission parameters for a second mission from the plurality of missions,
the first mission is assigned to a first unmanned vehicle from the plurality of unmanned vehicles, and
the second mission is assigned to a second unmanned vehicle from the plurality of unmanned vehicles.

15. The non-transitory processor-readable medium of claim 11, wherein:
the code to automatically output includes code to automatically output, to a user interface, the information related to the execution of each mission from the plurality of missions,
the information related to the execution of each mission from the plurality of missions is a representation of an avatar from a plurality of avatars, each unmanned vehicle from the plurality of unmanned vehicles is uniquely associated with an avatar from the plurality of avatars.

16. The non-transitory processor-readable medium of claim 15, wherein each avatar from the plurality of avatars is uniquely associated with an unmanned vehicle from the plurality of unmanned vehicles, the instructions comprising code to cause the processor to:
for each avatar from the plurality of avatars
receive an indication, via that avatar, to command and control (C2) the unmanned vehicle uniquely associated with that avatar and from the plurality of unmanned vehicles.

17. The non-transitory processor-readable medium of claim 11, the instructions comprising code to cause the processor to:
for each avatar from a plurality of avatars,
receive an indication, via that avatar, to command and control (C2) the unmanned vehicle uniquely associated with that avatar and from the plurality of unmanned vehicles;
automatically determine, via a first avatar from the plurality of avatars, that the operator cannot perform a first mission from the plurality of missions, the first avatar being uniquely associated with the first mission; and
automatically manage, via the first avatar, of the first mission in response to the determination that the operator cannot perform the first mission.

18. A system, comprising:
a mission management compute device configured to assign each mission from a plurality of missions to an operator from a plurality of operators, each operator from the plurality of operators being uniquely associated with at least two unmanned vehicles from a plurality of unmanned vehicles; and
a plurality of ground control compute devices operatively coupled to the mission management compute device, each ground control compute device from the plurality of ground control compute devices uniquely associated with an operator from the plurality of operators and the at least two unmanned vehicles uniquely associated with that operator,
the mission management compute device configured to automatically determine that an operator from the plurality of operators cannot perform a mission from the at least two missions associated with that operator,
the mission management compute device configured to automatically reassign the mission that cannot be performed by the operator, in response to the determination that the operator cannot perform the mission.

19. The system of claim 18, wherein:
the mission management compute device is configured to automatically reassign the mission that cannot be performed by the operator to the mission management compute device,
the mission management compute device is further configured to automatically manage the mission after the mission is reassigned.

20. The system of claim 18, wherein:
the operator is a first operator,
the mission management compute device is configured to automatically reassign the mission that cannot be performed by the operator to a second operator from the plurality of operators.

21. The system of claim 18, wherein:
each ground control compute device from the plurality of ground control compute devices is configured to automatically filter information unrelated to execution of each mission from the at least two missions associated with the operator for that ground control compute device while that mission is live,
each ground control compute device from the plurality of ground control compute devices is configured to automatically output information related to execution of each mission from the at least two missions associated with the operator for that ground control compute device while that mission is live.

22. The system of claim 18, wherein:
each ground control compute device from the plurality of ground control compute devices is configured to receive, via an avatar from a plurality of avatars, an indication to command and control (C2) the unmanned vehicle uniquely associated with that avatar and from the at least two unmanned vehicles for the operator associated with that ground control compute device;
each ground control compute device from the plurality of ground control compute devices is configured to automatically determine, via the avatar associated with that ground control compute device, that the operator for that ground control compute device cannot perform a mission from the at least two missions for that operator; and
each ground control compute device from the plurality of ground control compute devices is configured to automatically manage, via the avatar associated with that ground control compute device, the mission in response to the determination that the operator cannot perform the mission.
